(19) United States
(12) Patent Application Publication
(10) Pub. No.: US 2025/0055838 A1
(43) Pub. Date: Feb. 13, 2025

(54) FEDERATED IDENTITY RESOLUTION FRAMEWORK

(71) Applicant: LiveIntent, Inc., New York, NY (US)

(72) Inventors: Ilia Petriaev, Berlin (DE); Viktor Dreiling, Nidersachsen/Lower Saxony (DE); Mano Pillai, Chantilly, VA (US); Deepthi Venkitaramanan, Bolingbrook, IL (US)

(21) Appl. No.: 18/766,554

(22) Filed: Jul. 8, 2024

Related U.S. Application Data
(60) Provisional application No. 63/525,709, filed on Jul. 9, 2023.

(51) Int. Cl. H04L 9/40; H04L 67/146

(52) U.S. Cl. CPC H04L 63/0815; H04L 63/126; H04L 67/146

(57) ABSTRACT

The inventions disclosed herein relate to a federated identity resolution framework that provides resolution across any new market dominant identifier while respecting the usage guidelines for those identifiers, using a data store that can serve real time requests. There are two portions of this data store. The first portion contains raw emails associated with a fp cookie and can return the raw email of the user when a cookie/session id is passed as input. The second portion of the data store contains hashed email associated with other online identifiers.

### BACKGROUND OF THE INVENTION

### Field of Invention

The inventions disclosed herein generally relate to centralized units, that provide resolution across any new market dominant identifier while respecting the usage guidelines for those identifiers.

Usage guidelines may mean data governance adhering to the privacy regulations of different regions, as well as opt-outs of the specific identifiers (including site specific opt-outs, browser opt-outs, email newsletter opt-outs, opt outs specific to selling data vs sharing data). Examples may include GDPR, CCPA, Global privacy control flag, IAB global privacy platform, IAB Europe TCF, IAB Canada TCF and others.

### BRIEF DESCRIPTION OF THE DRAWINGS

FIG. 1 illustrates cookie cluster unification.

FIG. 2 illustrates UIDs.

FIG. 3 illustrates user authentication and tailored page and/or ads.

FIG. 4 illustrates email extensions and operation.

FIG. 5 illustrates enabling authenticated emails to web impressions.

FIG. 6 illustrates an exemplary login flow.

FIG. 7 illustrates an exemplary window.

FIG. 8 illustrates a exemplary potential system elements.

### DETAILED DESCRIPTION OF EMBODIMENTS OF THE INVENTION

Centralized unit here may be a data store that can serve real time requests. There may be two portions of this data store. The first portion contains raw emails associated with a fp cookie and can return the raw email of the user when a cookie/session id is passed as input. The second portion of the data store contains hashed email associated with other online identifiers including ip, maids, cookies (SSP and DSP 3p cookies), other identifiers recognized by DSPs that are generated in real time like UID2 tokens, Ramp ID envelopes etc.

This framework preferably allows for interoperability between identifiers and enriches the data connections for the data we acquire. E.g. Email hash and cookie linkages may be key factors for generating a majority of the deterministic identifiers. There are certain cookie-less identifiers that can be supported through the framework through use of attributes like ip, user agent, contextual bucket the user belongs to, etc.

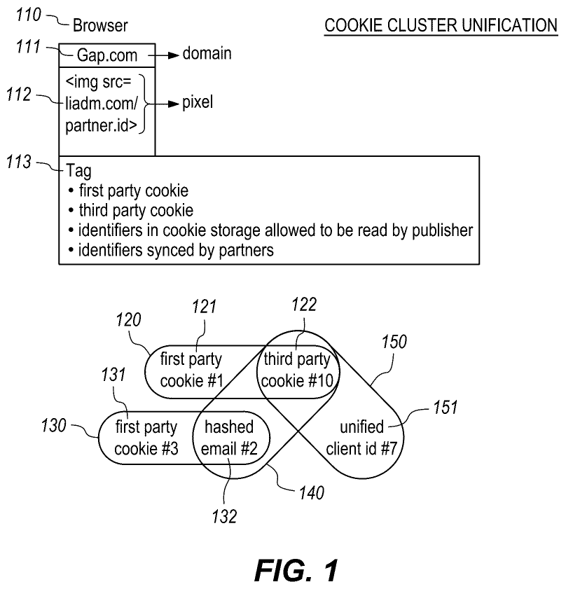

In addition, the real time endpoints preferably do a 2 step look up that connects a hashed email to a unified client identifier (an internal identifier that represents an app running on a device. More details on this in FIG. 1). All the partner specific identifiers synced to the graph using pixel sync are preferably mapped to the unified client identifier. So the two step traversal allows us to go from hashed email to the partner identifier at a device level.

It preferably also supports publishers who work with multiple identity providers. E.g. publishers, when they use LI prebid module, have an option to configure which of the identifiers they want to send over to the DSPs for the ad slots on their webpages. This allows us to shorten the list of identifiers and tailor it to suit publisher preferences. In addition this also prevents the bloating of responses with too many identifiers some of which may not even be sent by SSPs to the DSPs.

In the federated portion of the framework, we acquire data by resolving through varied identifiers and sources. For example, some of the DSP 3p cookies and DSP specific identifiers are obtained through a process called pixel syncing. Pixel syncing is a process in which partners can call an endpoint on page when an invisible pixel loads on page and inform LiveIntent of the identifier that uniquely represents the user on page in their system. This allows LiveIntent to make the nonId and the DSP identifier mapping that gets added to the identity graph.

In addition we help others resolve users by acting as a bridge identifier that works well with other market identifiers. For example, through the prebid module, whenever nonId is populated in the bids, we are also able to populate other identifiers associated with the nonId such as UID2 tokens, Ramp ID envelope etc.

We have an identity graph and we run campaigns in email media. Re the identity graph, the data collected from webpage through LiveConnect tags or other tags preferably include first party cookies, third party cookies, ip, user agent, url, along with hashed email passed from page if any and other identifiers synced on page through cookie syncing process described above.

Other data points includes identifiers publishers configure on page to be read by liveconnect tag from the cookie jar/local storage of the browser, data acquired or sourced from partners such as demographic data, ip, maids linked to hashes and the partner identifier—all of this are linked to the appropriate people id/email hash in the graph.

We later preferably have batch jobs that process these logs and create linkages. Two important aspects of identity graph may be: cookie cluster unification and uid to uid mapping on a high level. Cookie cluster unification is described in FIG. 1.

Right now two cookie clusters may be unified during the following cases:

Deterministic links between pair of identifiers that appear in the same log lines—this could be from identifiers passed on to us through LC tag, or other tag, through ‘identifiers to resolve’ parameter or similar, email hashes as well as identifiers read from local storage and cookie jars passed on to us—when two identifiers appear on logs in the same line, they are likely a part of the same event and the identifiers likely represent the same user.

When a partner pixel sync with us, they may call the pixel sync api endpoint to inform us of their identifier corresponding to the user on the page. LC tag preferably starts the sync container and receives incoming syncs from other partners as well as sends information like hash/nonId to other partners. This preferably results in a cluster of partner identifiers associated with identifiers collected from point 1 along with attributes like ip, device, user agent, event type, timestamp etc. Note, syncs may be sent directly to the IDAAS endpoint dedicated to pixel syncs. We may also send information to external partners (outgoing pixel syncs) based on whether we are able to have a nonId on page.

IP and geo trampolining may allow us to link clusters of identifiers that share the same ip address or geo coordinates.

First party (fp) and Third party (tp) cookies shared between a set of identifiers like hashes and IP.

### UID to UID Mappings (Client Identifier to Client Identifier Mappings)

Unified client identifiers may represent a set of all identifiers belonging to a specific browser (e.g. deterministic third party cookie linked to hashed email) and are preferably based on the assumption that client identifier linkages are deterministic. However, there are two other methods for making the cluster connected component method described above—partner pixel syncs and ip based linkages (both of which are probabilistic and can sometimes be weak linkages). This can result in rapid growth in the number of unified client ids as well as unusually large clusters in the graph.

By separating out the partner pixel syncs and ip based linkages as different algorithms and preferably retaining only deterministic unified client id and hash linkages, we may restrict hash to be stored alongside with only one unified id. Note, a hash can be connected to many UIDs (and vice versa). May have a restriction that each uid is stored with only one hash (but probably not the other way around).

We may split storage in a way that we store ids directly linked to specific uids in a specific store and the mappings between uids and their corresponding mapping types in a separate store. This approach allows us to strengthen or time decay mappings between a unified id and another unified id based on how frequently and recently they are observed. However, when such changes are made, it will preferably only impact that unified id and will not impact other unified ids the current unified id is mapped to. There also may be a mechanism to improve reach through the increase of the number of tiny clusters formed between client identifiers mapped to a specific unified id. Though these tiny clusters may not have mappings to other UIDs at the start, they may grow to form meaningful mappings to another UID client identifier mapping.

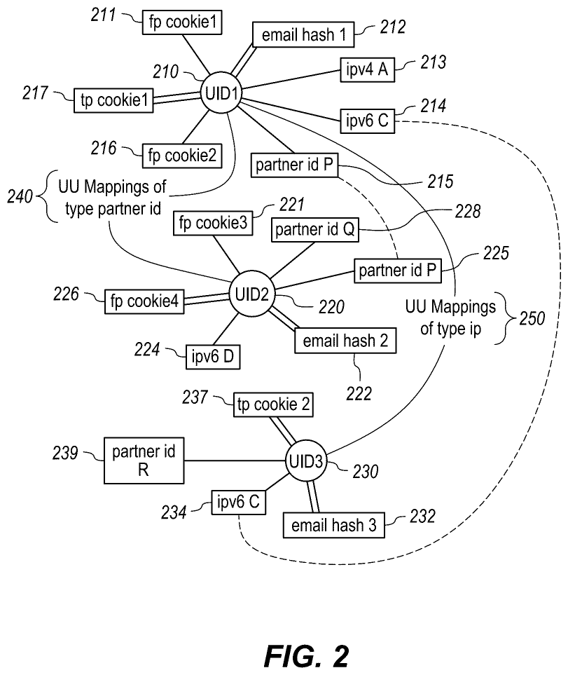

This helps makes our system resilient to probabilistic and low quality partner identifier syncing as they will be restricted to their own cluster and will not impact other deterministic linkages. See, e.g. FIG. 2.

In addition, our customers provide us with data from LCEE, CRM and ESPs. Our starting point of improving addressability for our clients is preferably through email clickout—a potential key differentiator when compared to other standard addressability improving projects.

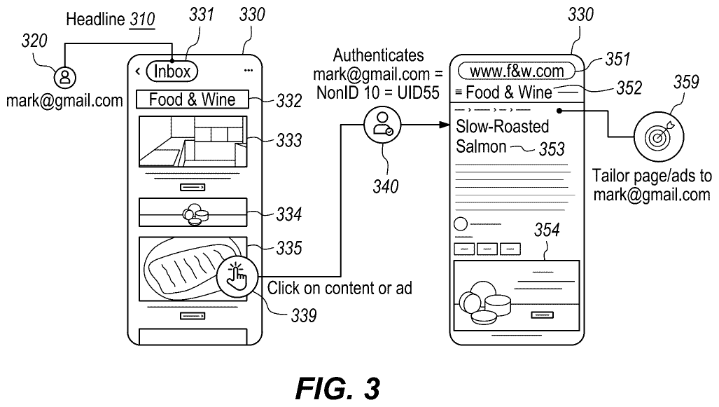

See FIG. 3 and FIG. 4 and FIG. 5 for how LCEE may work.

So far there are two main avenues for us to collect raw emails. Avenue 1: Ask pubs or publishers to give us their CRM data, preferably in the following format: Fp cookie, tp cookie and raw emails of their user base. Avenue 2: Combination of LCEE or other softclick logs and ESP click out logs.

Right now when a publisher domain has LiveConnect and the publisher participates in LCEE, they preferably append a unique ESP id representing the user in the email newsletter. When the user clicks on the email newsletter and lands on the webpage, the liveconnect tag collects esp id and the corresponding first party cookie.

When the publisher has provided us enough permission to obtain click out logs from the ESPs, we preferably get important information, the combination of all of this is very powerful. Here we get the email hash, ip, user agent and timestamp information.

Looking at the example log from ESP click out logs:

{“ClickDate”:“2022-08-08T14:30:00”,“LinkUrl”:
“https://www.choicehomewarranty.com/opt-
out/?ltkKey=#Listrak\\emailKey#”,“_sdc_table_version”:
0,“LinkDescription”:“unsubscribe”,“Ms
gID”:14017828,“_sdc_received_at”:“2022-08-
08T19:02:34Z”,“_sdc_sequence”:1659985260313094207,
“_sdc_batched_at”:“2022-08-
08T19:05:41Z”,“ContactID”:“79234444”,
“EmailAddress”:“example1@charter.net”}
{“ClickDate”:“2022-08-08T14:08:00”,“LinkUrl”:
“https://www.choicehomewarranty.com/opt-
out/?ltkKey=#Listrak\\emailKey#”,“_sdc_table_version”:
0,“LinkDescription”:“unsubscribe”,“Ms
gID”:14017828,“_sdc_received_at”:“2022-08-
08T19:02:34Z”,“_sdc_sequence”:1659985260313064201,
“_sdc_batched_at”:“2022-08-
08T19:05:41Z”,“ContactID”:“602341148”,
“EmailAddress”:“example2@gmail.com”}

Though the listed examples are opt-out logs and we may not be able to use it, we can make use of general content/ad link click out logs. We can use a combination of email hashed from this log and time stamp to map it to the corresponding esp log. Please note that in the above example, we can have LinkUrl which can contain the esp id sent by the publisher newsletter which can be used as the key to make the join. So this may essentially allow us to obtain the following data mapping: raw email, fp/tp cookie association to pre fill the prompt for the user on the page.

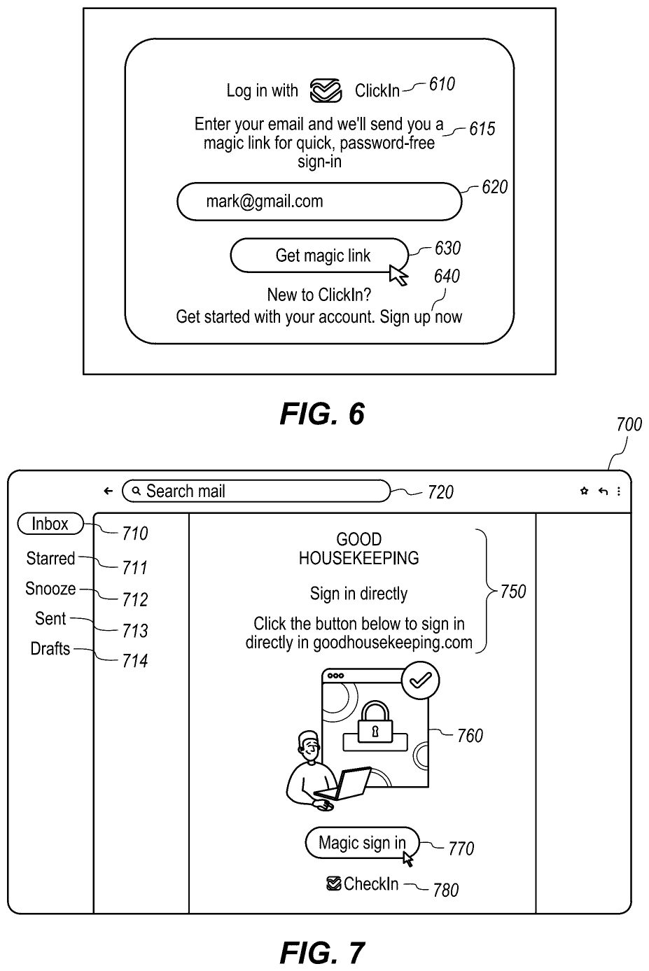

This ability to prefill prompts in Liveintent's single sign on solution with the raw email of the user so that the user can create an account with LI with 2 clicks—the first click to send a verification email with pre signed in url also known as magic link and the second click being from the email sent for verification which directly allows the user to sign in—is an important aspect of the federated id resolution framework. See, e.g., FIG. 6 and FIG. 7.

It is important to note that the raw emails in the ESP click out logs may be the actual emails from which the click happened. This information could be important for making the endpoints more secure.

For a non-logged-in non-registered user who is unwilling to submit an email, there may be two paths—content should still be inaccessible (locked away behind an enter your email prompt), or they could continue as anonymous user with limited access to resources on publisher website (We still may need a repeated identifier like open id to help publisher identify the visitor such as an fp cookie at least for the same device and same browser).

We preferably use a combination of data obtained from the above-mentioned sources and use our mapping algorithms to link the raw emails to the first party cookie on user pages. Note, the algorithms are described in section cookie clustering and UID to UID mapping above. When cookies are associated with hashes, there are preferably different types of linkages that allow us to connect a cookie to the hash.

When this mapping happens with the consent of the user, the user preferably becomes a part of the LI user network. This will essentially make the web traffic from the specific user addressable to all publishers belonging in the LI publisher network or similar and there may be multiple avenues for submitting the data back to publishers such as real time SVR or as signed in user through SSO. Publishers may also choose to enhance web requests with any identifier of choice that can directly be picked up by the prebid header bidding module. Some exemplary identifiers of choice may include UID2 tokens, Ramp ID envelope, Quantcast ID, Criteo ID etc.

Embodiments of the invention may include: federated identity resolution framework comprising: a federated identity resolution framework email extension; a unique identifier, the unique identifier being an ESP identifier, where the ESP identifier is associated with a user email in an ESP log, and where the ESP identifier maps the users cookies to the users plain text email; a single sign-on service provider; an email from a publisher, the email including the unique ESP identifier; a web page having a URL, the URL including the unique ESP identifier; a tag on the web page that collects the unique ESP identifier and the user's first and third party cookies; where when a user revisits the website, the single sign-on service provider queries the federated identity resolution framework, providing as input the users cookies, and receiving as output the users email address; and where the website uses the users email address to prefill a prompt in the user interface with the users email address, such that the user is able to login to the website with a single click and without having to enter their email address, the website having a verification email sent to the user at the users email address to verify the login.

Embodiments of the invention may include: centralized unit, a data store that can serve real-time requests, the centralized unit including two portions, a first portion containing raw emails associated with a fp cookie and that can return the raw email of a user when a cookie and/or session id is passed as input, and a second portion containing a hashed email address associated with other online identifiers including one or more of: IP, maids, cookies including SSP or DSP 3p cookies, and other identifiers recognized by DSPs that may be generated in real-time such as UID2 tokens and/or Ramp ID envelopes; data governance including identifier opt-outs; where the framework allows for interoperability between identifiers; and where the framework allows for the enrichment of data connections.

Embodiments of the invention may include: where the real-time endpoints do a two-step look up that connects a hashed email to a unified client identifier, where a unified client identifier is an internal proprietary identifier that represents an app running on a device; where partner specific identifiers are synced to a graph using pixel sync and mapped to a unified client identifier; supporting publishers working with multiple identity providers; where data is acquired by resolving through varied identifiers and sources; including an identity graph for running campaigns in email media; including batch jobs that process logs and create linkages; including cookie cluster unification; including deterministic UID to UID mappings; including user created accounts with two clicks, the first click to request a verification email be sent with a pre-signed URL and the second click being from the email sent for verification which allows the user to sign in upon the second click; and where raw emails are linked to first-party cookies on user pages.

For a more complete understanding of various embodiments of the present invention, reference is now made to the following descriptions taken in connection with the accompanying drawings.

FIG. 1 illustrates cookie cluster unification, including browser 110, domain 111, here Gap.com, pixel 112, and tag 113. Tag 113 may be an LC tag that collects: first party cookie; third party cookie; identifiers in cookie storage allowed to be read by publisher; and identifiers synced by partners. Tag 113 does into a graph mapped to an identifier called “unified client identifier”, which is preferably a connected component of all identifiers collected through logs. In internal representation could look like the lower portion of FIG. 1, including cookies 120, including first party cookie #1 121 and third party cookie #10 122, cookie and hashed email 130 including first party cookie #3 131 and hashed email #2 132, 140 including hashed email #2 132 and third party cookie #10 122, and 150 including third party cookie #10 122 and unified client id #7 151. This kind of representation allows us to build links and unify clusters through common third party cookies/IPs/MAIDs. Each of the above methods of unification may become a specific link type & algorithm.

FIG. 2 illustrates 3 UIDs, UID1 210, UID2 220, and UID3 230. UID1 210 is illustrated with fp cookie 1 211, email hash 1 212, ipv4 A 213, ipv6 C 214, UU Mappings of type ip 250, partner id P 215, fp cookie 2 216, and tp cookie 1 217. UID2 220 is illustrated with fp cookie 3 221, partner id Q 228, partner id P 225, email hash 2 222, ipv6 D 224, and fp cookie 4 226. UID3 230 is illustrated with tp cookie 2 237, UU Mappings of type ip 250, email hash 3 232, ipv6 C 234, and partner id R 239. How deterministic linkages are, or their accuracy, may depend on partner id accuracy. In case of cookie cluster unification, all 3 UIDs (UID1, UID2, and UID3) are considered to be belonging to the same cluster; all identifiers corresponding to all clusters are merged to a bigger cluster; this results in UID explosion combination. For UID to UID mapping, IDs corresponding to specific UIDs are stored with that ID and are not unified to the same clusters. Instead UID-UID mapping are stored in the format: UID1 UID3 ip-mapping with weight 0.7; UID1 UID2 partner-id-mapping with weight 0.3. This increases traversals to find linked hashes but allows us to preserve mapping quality types & mitigate certain disastrous cookie cluster unification that could emerge from low quality partner ids or proxy IPs.

FIG. 3 illustrates authentication of a user and tailor page/ads to the user. Headline 310 is illustrated, and user 320 including email address. The user's inbox 331 is illustrated on screen 330, including Food & Wine content 332, additional content 333, and more additional content 334 and 335. The user clicks on content or ad 339, the user is authenticated as email address mark@gmail.com=NonID 10=UID55 at step 340. On screen 350, website www.f&w.com 351 is loaded, including content 352, 353, and 354, and page/ads 359 are tailored to this user.

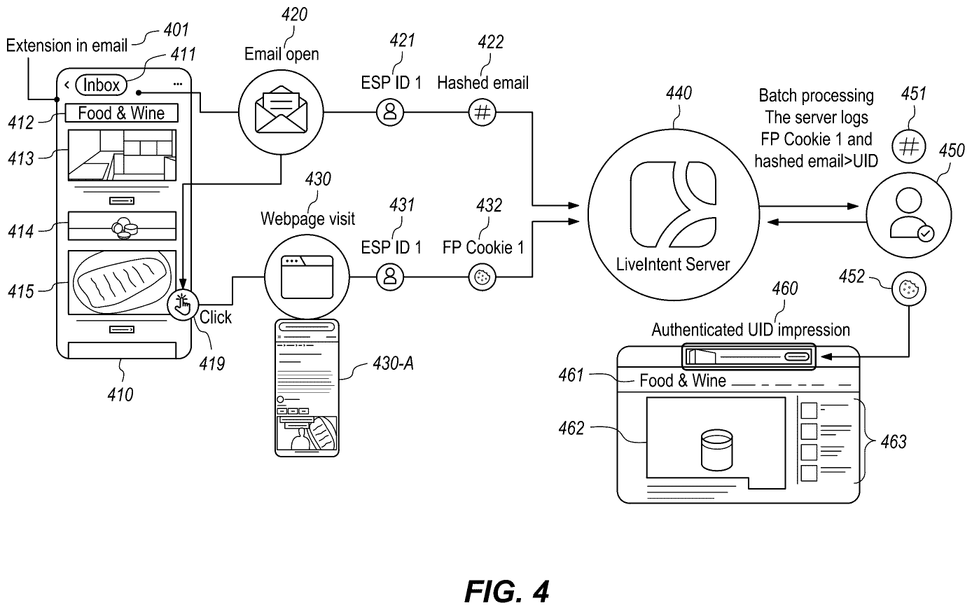

FIG. 4 illustrates how the LiveConnect Email Extension works. This starts with email extension in email 401, illustrated in Inbox 411, showing content 412, 413, 414, and 415 on screen 410, following email open 420. The user clicks 419, visits Webpage 430, showing content 430-A, with ESP ID 1 431 and FP Cookie 1 432. Following email open 420, ESP ID 1 421 and Hashed email 422 are illustrated, feeding into server 440, with batch processing the server logs FP Cookie 1 and hashed email>UID at 451, user is validated 450, and users cookie 452 is used for Authenticated UID impression 460, including content 461, 462, and 463.

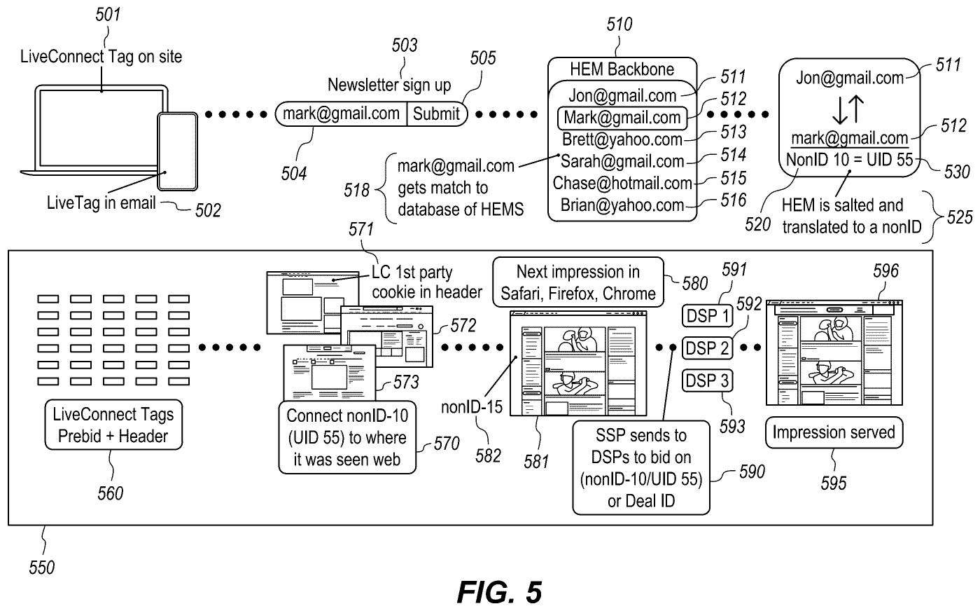

FIG. 5 illustrates Enabling Authenticated Emails to Web impressions, starting with LiveConnect Tag on site 501, or LiveTag in email 502, then Newsletter sign up 503, user mark@gmail.com 504 enters email and enters submit 505. HEM Backbone 510 is illustrated, with different user emails 511, 512, 513, 514, 515, and 516. At 518, user's email gets matched to database of HEMS. In this Database, user email 504 and 512 returns NonID 10 520 and UID 55 530. HEM is saled and translated to a nonID at 525. The lower portion of FIG. 5 includes 550, which includes LiveConnect Tags Prebid+Header 560, LC 1^{st} party cookie in header 571, content 572 and 573, and Connect nonID-10 (UID 55) to where it was seen on the web 570. On the next impression in Safari, Firefox, or Chrome 580 e.g., nonID-15 582 is used, SSP sends to DSPs to bid on (nonID-10/UID 55) or Deal ID 590, also illustrated are DSP 1 591, DSP 2 592, and DSP 3 593, and content 596 with impression served 595.

FIG. 6 illustrates Log in with ClickIn 610, enter email to send a magic link for quick, password-free sign-in 615, email input 620, get magic link 630, and click to sign up now 640.

FIG. 7 illustrates window 700, with Inbox 710, Starred 711, Snooze 712, Sent 713, Drafts 714, Search mail field 720, a Good Housekeeping mail 750, button 760 to sign in directly, Magic sign in 770, and CheckIn 780.

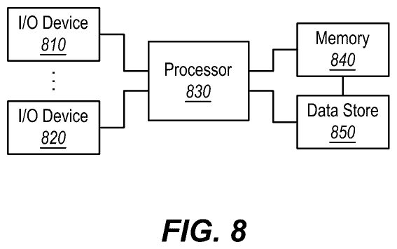

FIG. 8 illustrates exemplary potential system elements. As illustrated in FIG. 8, the system may include components including input/output device 810, input/output device 820, processor 830, memory 840, and data store 850.

As will be realized, the systems and methods disclosed herein are capable of other and different embodiments and its several details may be capable of modifications in various respects, all without departing from the invention. For example, specific implementation technology used may be different than those exemplified herein, but would function in a similar manor as described. Accordingly, the drawings and description are to be regarded as illustrative in nature and not in a restrictive or limiting sense.

Figures will be taken as nonlimiting.

1. A federated identity resolution framework comprising:
a federated identity resolution framework email extension;
a unique identifier, the unique identifier being an ESP identifier, where the ESP identifier is associated with a user email in an ESP log, and where the ESP identifier maps the users cookies to the users plain text email;
a single sign-on service provider;
an email, the email having one or more of content or an advertisement URL, one or more of content or an advertisement URL of the mail including the unique ESP identifier;
a web page having a URL, the URL including the unique ESP identifier;
a tag on the web page that collects the unique ESP identifier and the user's first and third party cookies;
where when a user revisits the website, the single sign-on service provider queries the federated identity resolution framework, providing as input the users cookies, and receiving as output the users email address;
and where the website uses one or more of the users email address or cookies to prefill a prompt in the user interface with one or more of the users email address or cookies, such that the user is able to login to the website with a single click and without having to enter their email address.

2. The federated identity resolution framework of claim 1, where the website has a verification email sent to the user at the users email address to verify the login.

3. A federated identity resolution framework comprising:
A centralized unit, a data store that can serve real-time requests, the centralized unit including two portions, a first portion containing raw emails associated with a fp cookie and that can return the raw email of a user when one or more of a cookie and session id is passed as input, and a second portion containing a hashed email address associated with other online identifiers including one or more of: IP, maids, cookies including SSP or DSP 3p cookies, and other identifiers recognized by DSPs that may be generated in real-time such as one or more of UID2 tokens and Ramp ID envelopes;
data governance including identifier opt-outs;
where the framework allows for interoperability between identifiers;
and where the framework allows for the enrichment of data connections.

4. The federated identity resolution framework of claim 3, where the real-time endpoints do a two-step look up that connects a hashed email to a unified client identifier, where a unified client identifier is an internal proprietary identifier that represents an app running on a device.

5. The federated identity resolution framework of claim 3, where partner specific identifiers are synced to a graph using pixel sync and mapped to a unified client identifier.

6. The federated identity resolution framework of claim 3, supporting publishers working with multiple identity providers.

7. The federated identity resolution framework of claim 3, where data is acquired by resolving through varied identifiers and sources.

8. The federated identity resolution framework of claim 3, including an identity graph for running campaigns in email media.

9. The federated identity resolution framework of claim 3, including batch jobs that process logs and create linkages.

10. The federated identity resolution framework of claim 3, including cookie cluster unification.

11. The federated identity resolution framework of claim 3, including deterministic UID to UID mappings.

12. The federated identity resolution framework of claim 3, including user created accounts with two clicks, the first click to request a verification email be sent with a pre-signed URL and the second click being from the email sent for verification which allows the user to sign in upon the second click.

13. The federated identity resolution framework of claim 3, where raw emails are linked to first-party cookies on user pages.
